(19) United States
(12) Patent Application Publication
(10) Pub. No.: US 2009/0272855 A1
(43) Pub. Date: Nov. 5, 2009

(54) Device

(75) Inventor: Robert Kenneth Oram, Cults (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Balmoral Comtec Limited

(21) Appl. No.: 12/387,095

(22) Filed: Apr. 28, 2009

(30) Foreign Application Priority Data
May 2, 2008 (GB) 0808005.3

(51) Int. Cl. F16L 3/10

(52) U.S. Cl. 248/67.5

(57) ABSTRACT

A clamp device suitable for attachment to a riser is disclosed. The clamp comprises a clamp body, a layer of resilient material provided on an inner face of the body, a tensioning band to secure the clamp around a riser and a tensile reinforcement layer located between the clamp body and layer of resilient material, wherein the tensile reinforcement layer comprises a high tensile modulus and high tensile strength material. The tensile reinforcement layer may be laminated onto the clamp body. The tensile reinforcement layer may be used with any suitable clamp.

### RELATED APPLICATION

This application claims priority from United Kingdom Patent Application Number 0808005.3 filed on 2 May 2008.

### FIELD OF THE INVENTION

This invention relates to a clamp device for securing buoyancy elements to underwater flowlines, risers and umbilicals.

### DESCRIPTION OF THE RELATED ART

In order to extract hydrocarbons from subsea wells, flowlines, often referred to as risers, extend from a wellhead to a surface facility, such as a production platform or production vessel. Risers are flexible and bend in response to prevailing underwater conditions. To manufacture flexible risers it is necessary to have an inner liner tube, tensile layers and an outer plastic sheath for protection from the sea. This sheathing has a low coefficient of friction with the inner tube of the riser and so is relatively delicate. Low coefficients of friction also exist between individual structural layers within the flexible riser.

In order to isolate subsea terminations from the effects of vessel movement under weather and tide effects, buoyancy modules are used to create particular configurations of risers, for example configurations known as ‘Lazy S’, ‘Lazy Wave’, ‘Lazy W’, between a Floating Production Storage and Offtake (FPSO) vessel and the seabed or floating subsea structure.

Moreover, the weight of the risers and hydrocarbons therein could be supported by the surface facility but would require strong risers and connections to maintain the integrity of a long string of risers. It is thus more economic to attach buoyancy elements to the risers to provide additional support.

Clamps can be used to fit around the riser and provide a mounting for a buoyancy element. However the attachment of the clamp must be done carefully since the sheath on the riser is liable to tear away from the underlying tensile layers of the riser if attachments thereto are over-tensioned. It is possible to make a rigid bodied clamp that is a perfect fit on a riser (the very earliest clamps were individually bored from aluminum castings to match particular locations on a riser) but it is expensive and not very practical as actual diameter of a flexible riser in practice can easily exceed ±3% of a given diameter.

In any case, the changes in internal and external pressure and temperature of the riser can result in a variance in the diameter of the riser and affect its connection to a clamp. Moreover the bending and tensile strains which occur in risers in use further hinder the correct dimensioning of rigid clamps. As a result manufacturing clamps with an exact fit for the flowlines was difficult and expensive and such clamps were in any case subject to failure due to the in situ variance in riser diameter.

A number of further clamps have been developed to mitigate these problems. One known clamp disclosed in GB 2,391,255 comprises a series of clamp segments shaped to fit around a riser, and a band with bars at either end. The band is wrapped around the clamp body, which is in turn arranged around the riser. The bars are bolted together in order to tension the band around the clamp segments and attach the clamp under tension to the riser. The buoyancy element can then be attached to the clamp.

Although somewhat satisfactory, performance limitations are constantly being challenged with demands for clamps to cope with larger buoyancy loads and deployment in rougher sea states, and to accommodate larger riser strains and tighter riser bend radii and high rates of change of these radii.

However, increasing the load capacity is limited by the low coefficient of friction between the outer sheath of the riser and the underlying tensile layers and between the tensile layers themselves.

A clamp which was developed to address these problems is disclosed in EP 1850044A. In this case a layer of resilient material, preferably rubber is provided on an inner face of the clamp between the clamp body and a riser.

In order to achieve the required clamp sliding resistance at an acceptable clamping load, the resilient layer is routinely significantly wider than the tension band producing the clamping load. As a result of this geometry and the compressible nature of the resilient layer, the tension band generates a high flexural stress in the clamp segments lying between the tension band and the resilient layer. Due to the clamp segment geometry in the area where the tension band leaves the nose of clamp segment, the flexural stress is typically at its highest approximately 10-30 mm back from the leading edges of the front clamp blocks.

The line of peak flexural stress runs circumferentially round the clamp, approximately along the midline of the clamp segments, with the peak stress locations being in the leading blocks, 10-30 mm back from their leading edges. This high flexural stress leaves the clamp segments susceptible to fracture in this area.

The present invention aims to provide a clamp which addresses this problem.

### BRIEF SUMMARY OF THE INVENTION

According to one aspect of the present invention there is provided a clamp device suitable for attachment to a riser, the clamp comprising:

a clamp body,

a layer of resilient material provided on an inner face of the body,

a tensioning band to secure the clamp around a riser; and

a tensile reinforcement layer located between the clamp body and the layer of resilient material,

wherein the tensile reinforcement layer comprises a high tensile strength and high tensile modulus material.

Due to its significantly higher modulus vs. the clamp block material, the tensile reinforcement layer acts to stiffen the clamp segments and reduce the flexural stress in the clamp segments.

Preferably the clamp device further comprises two or more tensile reinforcement layers.

Preferably, the tensile reinforcement layer is selected from fiber-reinforced composite material or corrosion resistant metal sheet.

Conveniently, each tensile reinforcement layer comprises two or more layers of fiber matting, laminated together and/or onto the clamp body.

Optionally the laminated mat material is polymer-impregnated.

Advantageously, the tensile reinforcement layer includes woven or non-woven mat material. Optionally, the mat material is a triaxial, biaxial or axial matting. Optionally, the mat may be woven or stitched.

Preferably, the fiber weight in the mat material is biased in one direction.

Preferably, the mat is made from fibers of any of glass, carbon, aramid, Dyneema® synthetic fiber or a combination thereof. Dyneema is a registered trademark of DSM Dyneema for synthetic fiber made from ultra high molecular weight polyethylene.

Optionally, the high tensile strength and high tensile modulus material is laminated onto the clamp.

Optionally, the bias of fiber weight in the lamination is in axial alignment relative to the riser.

Preferably, the layer of resilient material is provided on an inner concave face of the clamp body, bonded directly to the tensile reinforcement layer.

Preferably, the clamp body comprises a plurality of segments.

Preferably, the tensioning band has an axis bar at each end, and fastening means to draw the axis bars together.

Optionally, the resilient material is a rubber material.

Preferably, the resilient material is a natural rubber.

Conveniently, the resilient material has a thickness of at least 20 mm.

More preferably the resilient material has a thickness of at least 25 mm.

In one embodiment, the resilient material has a thickness which corresponds to 6-30% of the outer diameter of the riser.

Conveniently, the resilient material has a thickness which corresponds to 20-30% of outer diameter of the riser.

Conveniently, the resilient material may have a thickness which corresponds to 6-18% of the outer diameter of the riser

Preferably, the fastening means are two bolts provided on the bar adjacent to the band.

Optionally, the clamp body has a convex outer face.

Preferably, the band is supported between the bar and the body, thus preferably there is no gap there between. This allows the force from the band to be distributed more evenly.

Thus preferably the clamp body is in intimate contact with the band over the full width of the band. This is possible because the low shear modulus of the resilient rubber layer adjacent to the riser allows the clamp body to move radially when the band is being tensioned and thus remain in intimate contact with the band.

Preferably, a buoyancy element is secured to the riser via the clamp.

Thus the invention provides an apparatus comprising a clamp as described herein and a buoyancy module.

The invention also provides a riser apparatus comprising a clamp as described herein and a buoyancy module and a riser.

### BRIEF DESCRIPTION OF THE SEVERAL VIEWS OF THE DRAWINGS

Embodiments of the present invention will now be described, by way of example only, with reference to the accompanying drawings, in which:

FIG. 1 is an end view from above of a clamp comprising a tensile reinforcement layer of the invention;

FIG. 2 is a perspective view of the clamp of FIG. 1;

FIG. 3 is a perspective view of a plurality of buoyancy devices mounted on clamps in accordance with the present invention;

FIG. 4a is a diagram showing the change in dimension of known clamps caused by bending of risers; and

FIG. 4b is a diagram showing how the clamps in accordance with the present invention do not change in dimension when risers bend.

### DETAILED DESCRIPTION OF THE INVENTION

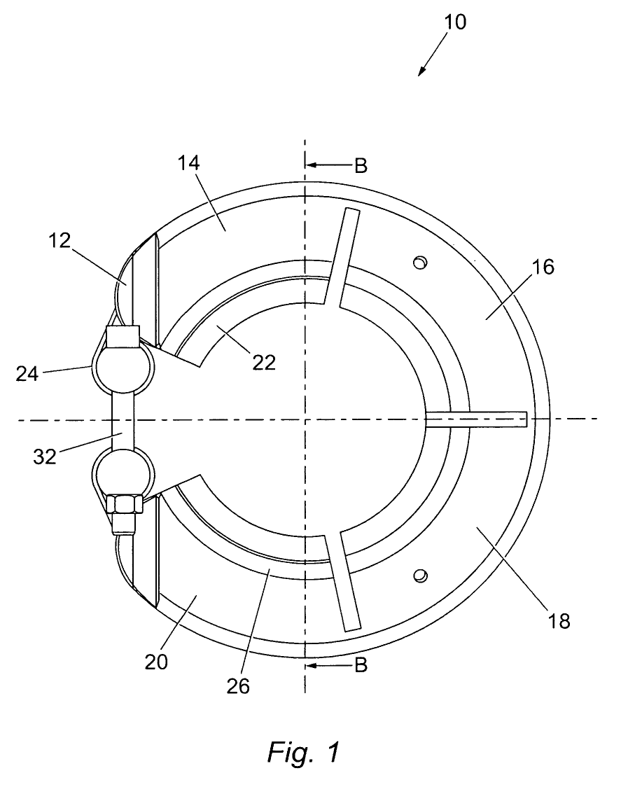

In a first embodiment the tensile reinforcement layer of the invention is used with a clamp as shown in FIG. 1, although it is envisaged that the tensile reinforcement layer of the invention may be used with any type of clamp. The clamp 10 comprises a plastics jacket 12 covering four clamp segments 14, 16, 18, 20, although clamps with other numbers of segments may also be used with the tensile reinforcement layer of the invention.

In the embodiment shown the jacket extends over substantially the top and side faces of the segments. However, the amount of coverage may vary depending on the operational requirements of the clamp and in some embodiments the jacket may only cover the outer convex face of the segments. Each segment comprises a concave inner face. A layer of rubber 22 is placed between the concave inner segment face and the article to which the clamp is attached when the clamp is in place. The outer convex face of the clamp is covered by tension band 24. As shown in FIG. 1, a tensile reinforcement layer 26 is provided between the inner concave surface of the clamp segment and the rubber layer 22. As would be understood by the person skilled in the art, the rubber layer can be made of any resilient material and is preferably, but not limited to, rubber, e.g. natural rubber.

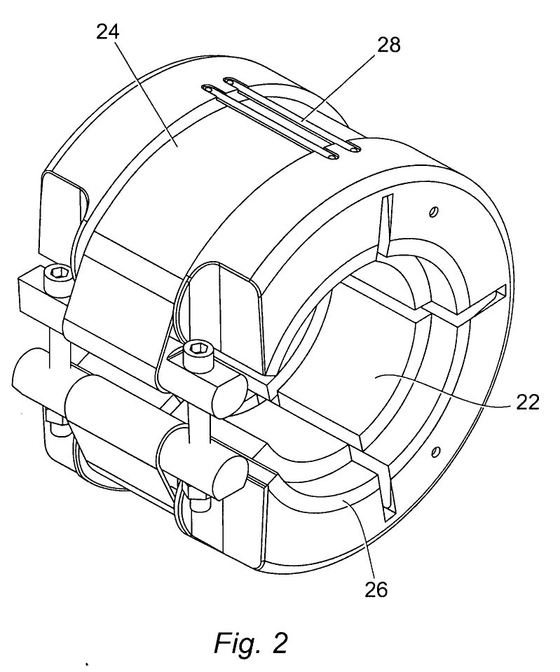

FIG. 2 illustrates a perspective view of the clamp of FIG. 1 where the rubber layer 22 is shown as a narrower layer than the tensile reinforcement layer 26. It is understood that the tensile reinforcement layer and the rubber layer may be the same or different widths in the axial direction relative to one another. FIG. 2 also illustrates band retainers 28 to hold the band on the surface of the clamp.

FIGS. 1 and 2 illustrate a continuous tensile reinforcement layer 26 across the entire inside surface of the front blocks of the clamp device, although it is understood that the tensile reinforcement layer may be discontinuous, partial or complete in coverage. The high tensile material may be present over the entire inside face of each block/segment, over the front clamp segments only, or only at points of high stress and/or peak stress on individual blocks. Intermediate amounts of the high tensile material may also be used. More than one tensile reinforcement layer can be used. Preferably two or more layers of tensile reinforcement matting are present in each layer.

The tensile reinforcement layer is made of any high tensile strength, high tensile modulus material, for example but not limited to, fiber-reinforced epoxy composites or corrosion resistant metal sheet. Epoxy composites are preferred to maximize inter-material bond strength. Triaxial unwoven/stitched matt with typical values of 0 degrees/45 degrees/45 degrees and 600/300/300 gm/m² weight is also suitable. Triaxial, biaxial or uniaxial, woven or non-woven mats can also be used in the tensile reinforcement layer, preferably with the fiber reinforcement of the composite being at least equal, and preferably significantly greater, bias in weight and/or strength in the axial direction of the riser after installation. Preferably, two layers of triaxial unwoven/stitched mat, 0 degrees/45 degrees/45 degrees, 600/300/300 gm/m² are used, with the major reinforcement in the 0 degree direction in both mattings being aligned in the axial direction.

Suitable matting materials are glass, carbon, aramid, Dyneema® or any other high strength, high modulus fiber or any combination of these. Where glass matting is used as the reinforcement layer, the total matting reinforcement weight should exceed 450 gm/m² and may be as high as 7200 mg/m². Other fiber matting weights should be used in quantities which are proportional to their tensile properties.

Preferably, the tensile reinforcement layer is laminated, the lamination being directional in its reinforcement properties. Preferably the bias of the lamination is towards axial alignment, i.e. in the direction of the riser and parallel to the clamp leading edge. Optionally, the tensile reinforcement layer may be pre-manufactured and be bonded onto the clamp body, rather than being created in situ by lamination.

The laminated material may include a resin, e.g. a polymer resin or epoxy resin. The laminated material may include polymer impregnated mat material, e.g. polymer-impregnated woven mat material. Other laminating or impregnating resins may be used with the tensile reinforcement layer of the invention, for example but not limited to, unsaturated polyester, vinyl ester or phenolic thermoset and/or thermoplastic resins. The type of resin to be used will vary depending on the nature of the clamp body onto which lamination occurs and the availability of suitable adhesives for bonding of pre-made laminates.

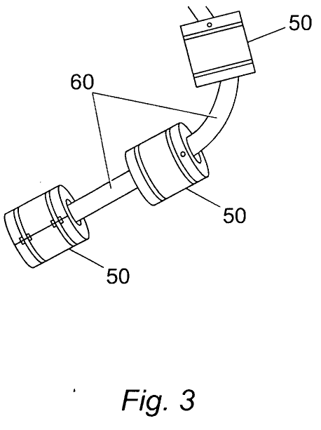

All the segments of the various clamp embodiments outlined above can be wrapped around a subsea riser 60. The bars, 28 are attached to the band 24 and are tightened together by bolts 32 thus tensioning the clamp around the riser 60, as described in more detail below. A buoyancy device 50 is then connected to the clamp by known means. The riser 60 is then fed through a moon-pool (not shown) or similar, with buoyancy devices being installed and launched sequentially. FIG. 3 shows three buoyancy devices 50 on a riser 60. The buoyancy devices 50 thus allow the riser string to flex in response to tide and wave conditions so that the connections between the surface facility (which may move in response to such conditions) and subsea wellhead or structure (which is substantially stationary) are not excessively stressed or broken. The clamp and the buoyancy devices 50, may be installed on either a horizontal or a vertical riser.

As will be noted from FIG. 3, the risers may be rigid and may be adapted to bend to cope with sea conditions. Thus the clamp 10 has to cope with such bending without losing its grip on the riser 60. Moreover the acceptable manufacturing tolerances on risers can cause their outer diameter to vary away from the declared size.

The rubber inner face 22 helps to cope with such difficulties, as seen in FIG. 2. In this preferred embodiment the rubber inner face 22 is provided in direct contact with the riser 60.

The resilient rubber layer next to the riser ensures that the radial distribution of the clamping pressure is improved, mitigating the capstan effect that is common to known clamp designs. In other words, the low shear modulus of the rubber allows the relative movement of the band and segments as if the band were in contact with a frictionless interface thus relieving tensioning variances within the band. Moreover this is achieved without reducing the friction necessary to prevent slippage.

Suitable materials for the rubber are those which not only have low stress relaxation rates, high resistance to seawater and high heat resistance but those that result in liquid like behavior under load, that is virtually no volume change under load (a Poison's ratio near to 0.5). Most grades of natural rubber have a value in excess of 0.49995. They also have very high resilience—when the load on it is reduced the rubber recovers rapidly. If this did not occur, slip could be possible when the riser contracts. Preferably the rubber is natural rubber such as Engineering Vulcanzate™.

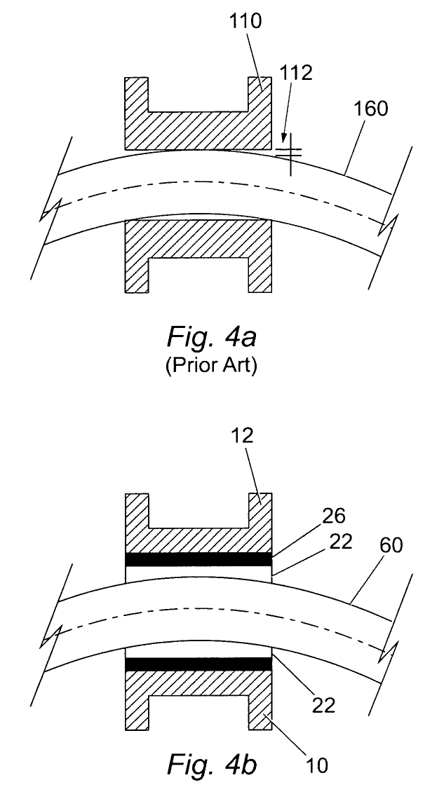

FIG. 4a shows a prior art clamp 110 and the consequential increase 112 in diameter following bending of a riser 160. The resultant large, cyclic increases in band tension will cause fatigue in the tensioning band. This does not occur with preferred embodiments of the present invention because the rubber layer 22 next to the riser 160 negates this effect, as shown in FIG. 4b. Thus embodiments of the present invention accommodate flexure of a riser from straight to minimum bend radius with no significant increase in the hoop load. As a consequence, fatigue of the tensioning band is not an issue.

The rubber layer also serves to accommodate large variations in diameter of the riser. Without such a rubber layer, even small dimensional variations due to manufacturing tolerances of the riser, it would not be possible to evenly tension a band around a stiff clamp body. Thus embodiments of the present invention benefit in that bending/flexure of the riser does not result in large load increases in the clamp or high local pressure increases on the riser.

The segments of the clamp 10 are manufactured from a fiber reinforced composites material which makes use of directional stiffness properties or molded from syntactic foams. Where directionally-reinforced material is used, the segments are very much stiffer in the axial direction than they are in the hoop wise direction. This allows for good load dispersal from the band 24 in the axial direction, for which stiffness is desirable, and compliance to the riser 60 geometry in the hoop wise direction thus enhancing the conformity of the clamp with the riser 60 whilst also providing support for a high loading of buoyancy elements.

The various features described herein of the preferred embodiment of the invention allow the clamp to resist tensile fractures and associated breaks. This is especially important where syntactic or similar foams are used in the clamp. Syntactic foams have low tensile strength especially if stress-concentrating micro-defects are present.

Such an advantage is provided in addition to the further embodiments described herein which provide a clamp resistant to tensile fractures and which can be tensioned very accurately with a more even load distribution across the width of the band, by hydraulic means which precludes galling and thread stripping, and allows for a fast yet accurate installation.

The design of the clamp segments with high axial stiffness and low hoop stiffness also enhances the even pressure distribution. The even pressure distribution is especially important since localized differences could cause the clamp to damage the internal reinforcement structure of the riser.

Thus embodiments of the present invention benefit in that the clamp is better able to accommodate variations in the riser diameter, both ovality and differences in the circumference measurement than is the case where a rigid clamp body is in direct contact with the riser or even where a rigid clamp body with a thin covering or coating.

The tensile reinforcement layer allows maximum advantage to be taken of the resilient layer without introducing risk of excessive clamp block flexure and potential fracture.

Improvements and modifications may be made without departing from the scope of the invention.

In a further embodiment the tensioning band may be a band having looped ends to provide a pocket for locating a connector. Each connector may have one or more aligned apertures to receive a fastening means such as a threaded bolt which passes through the apertures to span the connectors. The fastening means may be held in position either by corresponding threads on the connectors or a nut threaded onto the bolt. The band may be formed of a material such as Kevlar®.

In another embodiment, the layer of resilient material on each clamp body segment may be divided into sections, e.g. 2, 3 or 4 sections, in order to modify the compressibility of the layer of resilient material. By sectioning the layer of resilient material in this way the stiffness of the resilient layer is reduced. In a further embodiment, holes may be provided at numerous positions within the layer of resilient material to achieve the same result. Moreover, a segmented layer of resilient material may additionally comprise a plurality of holes.

As would be appreciated by the skilled person, the device of the present invention may be used to clamp any tubular member, such as but not limited to underwater flowlines, umbilicals and the like, without modification. Thus, the devices detailed above may be used to clamp flowlines, umbilicals and the like and the term riser should be taken to be interchangeable with other tubular members such as but not limited to flowlines and umbilicals.

As would be appreciated by the person skilled in the art, the thickness of the resilient layer varies depending on the outer diameter of the riser, flowline or umbilical to which it will be attached. In some embodiments, the resilient material has a thickness which corresponds to 6-30%, and any value in-between, of the outer diameter of the riser, flowline or umbilical.

In one embodiment the resilient material may have a thickness which corresponds to 5-15% of the outer diameter of the riser. Alternatively, the resilient material may have a thickness which corresponds to 8-12% of the outer diameter of the riser.

Umbilicals typically require a thicker resilient layer to compensate for the compression experienced by the umbilical. A clamp of the present invention for use with an umbilical typically includes a resilient layer with a thickness which corresponds to 22% to 30% of the outer diameter of the umbilical, preferably 24%.

Additionally, using clamps operating on umbilicals and/or on insulated risers, the clamp is required to accommodate more elastic expansion plus more elastic and inelastic compression. Accordingly, the resilient layer may have a thickness which corresponds approximately to 24% of umbilical/riser outer diameter, with a practical range of 20-30%.

In another embodiment, using clamps operating on un-insulated flexible flowlines and risers, elastic expansion plus elastic & inelastic compression are smaller. Accordingly, the resilient layer may have a thickness which corresponds to 12% of flexible pipe outer diameter, with a practical range of 6-18%.

1. A clamp device suitable for attachment to a riser, the clamp comprising:
a clamp body,
a layer of resilient material provided on an inner face of the body,
a tensioning band to secure the clamp around a riser; and
a tensile reinforcement layer located between the clamp body and layer of resilient material,
wherein the tensile reinforcement layer comprises a high tensile modulus and high tensile strength material.

2. A clamp device as claimed in claim 1, further comprising two or more tensile reinforcement layers.

3. A clamp device as claimed in claim 1, wherein the tensile reinforcement layer is selected from fiber-reinforced composite or corrosion resistant metal sheet.

4. A clamp device as claimed in claim 1, wherein the tensile reinforcement layer includes woven mat material.

5. A clamp device as claimed in claim 1, wherein the tensile reinforcement layer includes non-woven mat material.

6. A clamp device as claimed in claim 4 wherein the mat material is polymer-impregnated.

7. A clamp device as claimed in claim 4, wherein the mat material is triaxial, biaxial or axial.

8. A clamp device as claimed in claim 4, wherein the mat is stitched.

9. A clamp device as claimed in claim 4, wherein the mat material is biased in weight and strength in the axial direction.

10. A clamp device as claimed in claim 4, wherein the mat material comprises any of glass, carbon, aramid, a high molecular weight polyethylene synthetic fiber or a combination thereof.

11. A clamp device as claimed in claim 1, wherein the high tensile modulus and high tensile strength material is laminated onto the clamp.

12. A clamp device as claimed in claim 11 wherein the lamination is biased in weight and/or strength towards axial alignment relative to the riser.

13. A clamp device as claimed in claim 1, wherein the layer of resilient material is provided on an inner concave face of the body.

14. A clamp device as claimed in claim 1, wherein the clamp body comprises a plurality of segments.

15. A clamp device as claimed in claim 1, wherein the tensioning band has an axis bar at each end, and fastening means to draw the axis bars together.

16. A clamp device as claimed in claim 1, wherein the resilient material is a rubber material.

17. A clamp device as claimed in claim 1, wherein the resilient material has a thickness of at least 20 mm.

18. A clamp device as claimed in claim 17, wherein the resilient material has a thickness of at least 25 mm.

19. A clamp device as claimed in claim 1, wherein the resilient material has a thickness which corresponds to 6-30% of the riser diameter

20. A clamp device as claimed in claim 19, wherein the resilient material has a thickness which corresponds to 20-30% of the riser diameter.

21. A clamp device as claimed in claim 19, wherein the resilient material has a thickness which corresponds to 6-18% of the riser diameter.

22. A clamp device as claimed in claim 1, wherein the clamp is made from a material which has a higher axial strength than radial or hoop strength.

23. A clamp device as claimed in claim 15, wherein the fastening means are two bolts provided on the bar adjacent to the band.

24. A clamp device as claimed in claim 1, wherein the clamp body has a convex outer face.

25. An apparatus comprising a clamp device as claimed in claim 1 and a buoyancy module.

26. A riser apparatus comprising a clamp device as claimed in claim 1 and a buoyancy module and a riser.
